(19) United States
(12) Patent Application Publication
(10) Pub. No.: US 2016/0210576 A1
(43) Pub. Date: Jul. 21, 2016

(54) Method for Product Design

(71) Applicant: The Procter & Gamble Company, Cincinnati, OH (US)

(72) Inventors: Ben Weinstein, Wyoming, OH (US); Christopher Gerold Stoltz, Mason, OH (US); Jose M. Ortega, Cincinnati, OH (US); Brooks Montgomery Stein, Hamilton, OH (US); Edward Dewey Smith, III, Mason, OH (US); Henrique Aveiro, Deerfield Township, OH (US)

(21) Appl. No.: 14/601,272

(22) Filed: Jan. 21, 2015

(51) Int. Cl. G06Q 10/06; G06Q 10/08

(52) U.S. Cl. CPC G06Q 10/06313; G06Q 10/083

(57) ABSTRACT

A computer implemented method for defining transport logistic needs for a product includes steps of: creating a probabilistic model of the weather along a designated transport route; simulating the environmental exposure of the product as it traverses the route, determining any affects the environment may have upon the product and altering at least one of the product, product packaging, and transport route according to that determination.

### FIELD OF THE INVENTION

The invention relates to computer implemented methods for designing a product or product offering. The invention relates particularly to methods for designing product offerings including consideration of the necessary logistic elements associated with the entire manufacturing and distribution chain for the product offering.

### BACKGROUND OF THE INVENTION

The existence of broad geographic distribution networks for consumer products is well known. Such networks provide for the manufacturing of consumer products at a particular location and the subsequent distribution of those products across geographies spanning multiple states, and often multiple countries. The logistic realties of these distribution networks include the time it takes products to pass from an origin to a destination, the nature of the mode of transport including the packaging associated with the product and shipment of the product, and the environmental conditions to which the product may be exposed during the transit of the distribution network.

For some products, there are environmental sensitivities which may result in an alteration of the product due to environmental exposure during transit and possibly a degradation of the product in terms of shelf life or product performance. Evaluation of the environmental exposures may be undertaken by monitoring the exposure during actual transit. Such methods are time consuming and not necessarily accurate in terms of capturing the full breadth of actual exposure data required. What is desired is a method for quickly and efficiently determining the environmental exposure a particular product may be exposed to in terms of any product altering environmental limits such that alterations to the overall product offering in terms of the product formulation, packaging or shipment logistics may be evaluated in support of actual changes to the product, package or logistics.

### SUMMARY OF THE INVENTION

A computer implemented method for the design of a product or product offering. The method includes steps of: providing the product's environmental sensitivity profile, providing the product's shipment configuration profile, selecting a product shipment path, creating a weather model associated with the product shipment path, simulating the weather along the path during the selected timing, calculating the environmental exposure of the product according to the shipment configuration profile and the simulated weather, determining adverse product effects according to the environmental exposure and the environmental sensitivity profile, altering (as necessary) at least one of the: product, product shipment configuration, and product shipment path according to the determined adverse product effects.

### DETAILED DESCRIPTION OF THE INVENTION

As used herein, the term product and product offering are used interchangeably to refer to one or more consumer products are include all the various aspects of such products. Included in the terms are the consumable substance(s) of the product, the primary, secondary, tertiary, etc packaging associated with that substance and the respective portions of the packaging such as package bodies, closures, dispensing elements, labels, overwraps, cartons and cases.

As used herein the term environment refers to one or more a set of respective environments including the local environment of the product offering, the area in the immediate vicinity of the product offering—including the interior of a container or trailer, warehouse, retail location or residence. The environment may also include the general ambient environment external to the container, warehouse, residence etc.

The computer implemented methods of the invention provide an indication of changes to products during the shipment and storage phases of the product's lifecycle, i.e., instability. Such altering circumstances are indicated with consideration of the product itself as well as the packaging of the product and the level of aggregation of the product during each particular portion of the logistics chain under consideration. Exemplary levels of aggregation include: package, case, or pallet. Additional inputs relate to the specific route over which the product will travel.

The fidelity of the results to reality is directly associated with inputs provided by the user with regard to the factors taken into consideration. Users of the methods provide inputs relating to: the route, the product, the primary and secondary packages, the level of aggregation, and the date (which relates to the anticipated weather). The route may be defined by a user selecting a series of ‘legs’ that represent the path a shipment takes from origin to destination. A ‘leg’ is defined as a segment of the journey (either a location at which the product sits stationary for some time or a distance over which the product is moving). The route may be defined using an arbitrary number of legs in order to provide the desired level of granularity.

For each leg, the user must specify: the type of environment the product is experiencing, exemplary choices include shipping container (on land), shipping container (ocean), trailer, warehouse, store storage, store shelf/home; the level of aggregation, exemplary choices include palletized, individual case, or individual product; whether or not the shipment is stationary or moving during the leg; and the duration for which the product is being shipped through this leg. The duration is represented by a distribution of times. The distribution may be selected from a number of possible distributions, including but not limited to Uniform, Gaussian, and Poisson. Based on the type of distribution chosen, the user must supply the parameters required to adequately describe the distribution.

In one embodiment, for each leg of the journey, the user must specify the setup for that leg. The setup includes: specifying time constants, or other parameters, as well as heat and mass transfer model parameters for each product of the leg. Each product to be considered in a given leg is represented by a set of model parameters (either manually specified by the user or selected from a database of previously measured values) for each applicable leg environment.

When the level of aggregation associated with the leg is ‘palletized’, the user may specify model parameters as well as heat and mass transfer models to reflect the behavior of products located throughout the pallet.

When the level of aggregation associated with the leg is ‘case’, the user may specify one or more model parameters to reflect the behavior of products in different positions within the case. When the level of aggregation associated with the leg is ‘product’, the user may specify one or more models to reflect the behavior of an individual product. The models may be based upon fundamental heat and mass transfer principles, or may be simply assigning a constant value to the parameters for the product.

For each type of environment, the user may specify a specific setup for that leg. When the environment type is ‘trailer’, the user may specify: Ambient—no further input needed; models incorporating ambient weather conditions (e.g. temperature, wind speed, solar radiation, cloud cover, humidity) and the geometry and thermophysical properties of the container will be used to determine the environmental conditions inside the container, or Fixed—user must specify the environmental conditions at which the trailer will be held constant.

When the environment type is ‘seatainer (land)’, the user may specify either: Ambient—no further input needed; models incorporating ambient weather conditions (e.g. temperature, wind speed, solar radiation, cloud cover, humidity) and the geometry and thermophysical properties of the container will be used to determine the environmental conditions inside the container, or Fixed—user must specify the environmental conditions at which the seatainer will be held constant.

When the environment type is ‘seatainer (ocean)’, the user may specify either: Ambient—no further input needed; models incorporating ambient weather conditions (e.g. temperature, wind speed, solar radiation, cloud cover, humidity) and the geometry and thermophysical properties of the container will be used to determine the environmental conditions inside the container, or Fixed—user must specify the environmental conditions at which the seatainer will be held constant.

When the environment type is ‘warehouse’, the user may specify: Fixed—user must specify environmental conditions at which the warehouse will be held constant, Daily min/max—user must specify average daily min/max environmental conditions on a monthly basis, or, Select from database—user may select a warehouse environmental profile from a database of known profiles.

When the environment is ‘store storage’, the user may specify: Ambient—no further input needed; models incorporating ambient weather conditions (e.g. temperature, wind speed, solar radiation, cloud cover, humidity) will be used to determine the environmental conditions inside the container, Winter heating only—user must specify a minimum temperature to which the store will be held; models incorporating ambient weather conditions (e.g. temperature, wind speed, solar radiation, cloud cover, humidity) will be used to determine the environmental conditions inside the container, subject to the specified minimum temperature, Fixed—user must specify environmental conditions at which the store will be held constant, or Daily min/max—user must specify average daily min/max environmental conditions on a monthly basis

When the environment is ‘home’, the user may specify: Ambient—no further input needed; models incorporating ambient weather conditions (e.g. temperature, wind speed, solar radiation, cloud cover, humidity) will be used to determine the environmental conditions inside the container, Winter heating only—user must specify a minimum temperature to which the home will be held; models incorporating ambient weather conditions (e.g. temperature, wind speed, solar radiation, cloud cover, humidity) will be used to determine the environmental conditions inside the container, subject to the specified minimum temperature, Fixed—user must specify a environmental conditions at which the home will be held constant, or Daily min/max—user must specify average daily min/max environmental conditions on a monthly basis.

Once all legs have been defined, the user must specify the scenario(s) and failure model(s) of interest.

The user may specify any range of shipping dates across a calendar year for which to consider product stability. The user may select from a number of predetermined scenarios or manually fill in a custom set of shipping dates.

The user must also specify a number of statistical weather trajectories to consider for each specified shipping date.

The user may specify one or more failure modes of interest

Acute failure—defined as a failure that occurs when the product state deviates outside defined range; this could represent a product temperature becoming sufficiently high for a sufficiently long period of time so as to cause a melt failure, or sufficiently low so as to cause a freeze failure.
ser may specify multiple types of acute failure possibilities. For each acute failure type, the user must specify the associated failure conditions.

Cumulative failure—defined as a failure in which some describable parameter changes over time, at a rate that varies depending on the state of the product, until the parameter surpasses some specified limit. An example of such a failure is a pharmaceutical containing an active ingredient that degrades over time, with the degradation rate being a function of temperature and/or humidity.

The user may select an appropriate type of kinetic model (e.g. 0th order, 1st order) from a menu of preexisting models or may describe a custom kinetics model if desired.

The user may enter, or select from a database, the appropriate parameters to describe the kinetic model. For example, a 1st order reaction model is defined by a pre-exponential factor, activation energy, initial value for the parameter of interest, failure value for the parameter of interest, and asymptotic value for the parameter of interest.

For each leg in the defined route, a search may be performed to generate a list of possible NOAA weather stations at increasing distances within a 1 degree latitude/longitude window about that location.

Beginning with the closest station, the entire available weather history for that station may be downloaded from available data sources (e.g. NOAA, SolarAnywhere, GeoModel/SolarGIS climData, etc.). The data file may be parsed as follows: data is filtered to remove partial and/or empty records, data is interpolated to patch gaps up to a specified threshold and to assign data to a consistent hourly basis (weather data typically recorded down to the minute with some irregularity in the recording intervals; interpolation regularizes the records), and data is filtered to remove outliers to correct errors within the data record.

In one embodiment, the data filters may be set to eliminate points in which the temperature is more than 6 sigma away from the mean and more than 15 C away from the mean for a particular time point.

A point may be compared against the remaining population of data at that time point, excluding the point being considered to determine if the point is an outlier.

The parsed data record may be analyzed to ensure that a sufficient basis for creating a weather model for the location of interest (in one embodiment this determination requires at least 12 data points at each Julian hour of the year). This minimum basis value is tied to the size of the window for ‘indistinguishable weather’ described below.

If insufficient data is available, the next weather station in the list is considered and the data for that station may be downloaded. Any new weather data is added to the previous database, and the ‘cleaning’ process is repeated using the new larger dataset.

In one embodiment, when two weather stations have a recording at the same historical time, both records are kept for statistical purposes. However, only one point is counted towards the basis set for that particular Julian hour.

In the event that the end of the list of available weather stations is reached and a sufficient dataset for the model has not been compiled, the user is notified that locations without sufficient data are being considered and an alternative weather definition is required (exemplary alternatives include: enlarging the search pool, finding other data sources, and using a coarse min/max approach, etc).

Once an appropriate database is available for a given location, a statistical weather model that is able to produce weather trajectories for that location that are statistically consistent with the overall weather patterns based on the time of year may be built. The weather model and associated trajectories may include temperature and moisture data for the location.

The weather model may be initiated by selecting a weather state at random from the distribution of potential weather possibilities based on the initial location and start time for the shipment.

When transitioning from one geographical location to another adjacent location, the state vector of weather variables from the exiting location may be used to set the conditional probability structure of the next time step in the new location.

The time sequence may be modeled as a Markov chain with the transition probability characterized using a Bayesian multinomial-Dirichlet model, and the continuous variables discretized adaptively according to the nature of the data available to characterize each individual transition.

The weather pattern for any single day of the year may be assumed to be indistinguishable from any other day within a user defined time window of +/− x days allowing for incorporation of data from within this time window to enlarge the statistical basis for each hourly time point. Exemplary time windows include +/− 1, 7, 14, and 30 days.

For example, it may be assumed that the distribution of weather possibilities on January 15th of a given year will be indistinguishable from those of January 14th or January 16th (x=1). Thus, data points from a particular hour on all three dates may be used to represent possibilities for that particular hour on January 15th.

The trajectories generated by the model and the ones from which the model were created (i.e. real data) should have similar statistical properties, including: marginal distributions for each variable at a given hour/day/location; covariance of the multivariate random vectors for each hour/day/location; and autocorrelation at different time lags.

Weather models for each named location may be stored in a database for future reference to avoid the computational cost of building the location model with each new simulation.

Once weather models have been generated for all locations in the defined route, weather trajectories may be generated using the weather models for each location. Consistency is enforced between weather models for subsequent locations when transitioning from one location to the next. Trajectories provide a set of weather conditions at regular intervals (e.g. hourly) across the entire duration of the journey.

Once all trajectories have been developed, the weather conditions may be used as inputs for a series of heat and mass transfer models to compute the environmental conditions surrounding the product as well as the product temperature and moisture/humidity exposure at regular intervals (e.g. hourly) across the entire duration of the journey. The environmental conditions surrounding the product are determined based on the user inputs for each leg, as described above.

The product temperatures and environmental moisture are determined according to a series of models that are driven by the environmental temperature.

Both the environment and product temperatures are tracked and stored throughout each entire trajectory to provide a basis for statistical analysis and failure likelihood.

The environmental calculations yield a set of environment and product temperature trajectories. A number of calculations may be undertaken based on these trajectories.

Exemplary calculations include: failure analysis and environmental analysis. Failure analysis includes: Acute and cumulative failures. Cumulative change for a defined period of time may also be calculated in order to determine the shelf-life of the product.

Environmental analysis may include the determination of worst-case weather and/or environmental scenarios a product may see in transit; and the comparison of climate conditions between shipping channels in disparate regions around the globe.

Based on the types of failure modes that the user selects, the simulation will calculate many different quantities of interest. Exemplary quantities include: product change, mean kinetic temperature, product shelf life, cumulative failure, hot failure, cold failure, product change distribution, mean kinetic temperature distribution, product change by location, container cumulative cold and/or hot time, and cumulative product cold and/or hot time.

Product Change indicates the cumulative degradation of a product based on the start date of the shipment. The different lines correspond to different quantiles from the distribution of replicate weather trajectories.

Mean Kinetic Temperature indicates the mean kinetic temperature of a product based on the start date of the shipment. The different lines may correspond to different quantiles from the distribution of replicate weather trajectories.

Product Shelf Life indicates the product shelf life based on the start date of the shipment. The different lines may correspond to different quantiles from the distribution of replicate weather trajectories.

Cumulative Failure indicates the fraction of shipments that failed due to reaching the end of their shelf life during the simulation as a function of the start date of the shipment.

Hot Failure indicates the fraction of shipments that failed due to reaching the maximum temperature threshold during the simulation as a function of the start date of the shipment. A product may be considered to have failed if the temperature reaches the threshold at any point, regardless of the duration.

Cold Failure indicates the fraction of shipments that failed due to reaching the minimum temperature threshold during the simulation as a function of the start date of the shipment. A product may be considered to have failed if the temperature reaches the threshold at any point, regardless of the duration.

Product Change Distribution indicates the distribution of degradation amounts for all replicates for a particular shipment start date. The start date can be adjusted using the slider bar beneath the graph.

Mean Kinetic Temperature Distribution indicates the distribution of mean kinetic temperatures for all replicates for a particular shipment start date. The start date can be adjusted using the slider bar beneath the graph.

Product Change by Location indicates the mean amount of product degradation per location for a particular shipment start date. The start date can be adjusted using the slider bar beneath the graph.

Cumulative Container Cold Time indicates the average cumulative number of hours that the container temperature is expected to spend below various threshold temperatures as a function of start date for the shipment.

Cumulative Product Cold Time indicates the average cumulative number of hours that the product temperature is expected to spend below various threshold temperatures as a function of start date for the shipment.

Cumulative Container Hot Time indicates the average cumulative number of hours that the container temperature is expected to spend above various threshold temperatures as a function of start date for the shipment.

Cumulative Product Hot Time indicates the average cumulative number of hours that the product temperature is expected to spend above various threshold temperatures as a function of start date for the shipment.

Worst-Case Scenarios calculated by the simulation may include: container/product average temperatures, container/product extreme temperatures, container/product acute cumulative excursion time, container/product acute longest excursion times, and number of container/product acute excursions.

Container average temperature indicates the max/min average container temperature over an entire shipment for the worst-case trajectory from the full ensemble of weather trajectories for a given shipment start date. This is one of multiple methods for designating a ‘worst-case’ scenario.

Product average temperature indicates the max/min average product temperature over an entire shipment for the worst-case trajectory from the full ensemble of weather trajectories for a given shipment start date.

Container extreme temperatures indicates the max/min container temperatures achieved by the worst-case trajectory from the full ensemble of weather trajectories for a given shipment start date. This is one of multiple methods for designating a ‘worst-case’ scenario.

Product extreme temperatures indicates the max/min product temperatures achieved by the worst-case trajectory from the full ensemble of weather trajectories for a given shipment start date.

Container acute cumulative excursion time indicates the cumulative number of hours the container temperature exceeds the established max/min temperature thresholds for the worst-case trajectory from the full ensemble of weather trajectories for a given shipment start date. These trajectories could include many short excursions or few long excursions; it is only the cumulative total amount of time that designates it as a ‘worst-case’ scenario.

Product acute cumulative excursion time indicates the cumulative number of hours the product temperature exceeds the established max/min temperature thresholds for the worst-case trajectory from the full ensemble of weather trajectories for a given shipment start date. These trajectories could include many short excursions or few long excursions; it is only the cumulative total amount of time that designates it as a ‘worst-case’ scenario.

Container acute longest excursion time indicates the length of time the container temperature spends above/below the established max/min temperature thresholds during a single excursion for the worst-case trajectory from the full ensemble of weather trajectories for a given shipment start date.

Product acute longest excursion time indicates the length of time the product temperature spends above/below the established max/min temperature thresholds during a single excursion for the worst-case trajectory from the full ensemble of weather trajectories for a given shipment start date.

Number of acute container temperature excursions indicates the number of times the product temperature exceeds the established max/min temperature thresholds for the worst-case trajectory from the full ensemble of weather trajectories for a given shipment start date. This is one of multiple methods for designating a ‘worst-case’ scenario.

Number of acute product temperature excursions indicates the number of times the container temperature exceeds the established max/min temperature thresholds for the worst-case trajectory from the full ensemble of weather trajectories for a given shipment start date.

The methods may further be used to calculate a number of event trajectories associated with hottest and/or coldest, average and/or single, container and/or product trajectories, as well as determining the extremes in terms of time and temperature event trajectories along the route during the specified shipment times.

The methods of the invention may be carried out using a personal computer or PC. As used herein, the term “personal computer” (or “PC”) refers to a computer associated with a particular user or a particular user's household, rather than a centralized server or other computer system which processes or stores data for a plurality of users or households. However, the term “personal computer” is not limited to traditional desktop computers. Rather, “personal computer” generally includes any computing device having a CPU, memory, a visual display device (e.g., a display screen, a printer, etc.), and an input device (e.g., a keyboard, mouse, touch sensitive screen, etc,). By way of example, a personal computer may include a desktop PC, a notebook PC, a tablet PC, a personal digital assistant (PDA), a wireless computing device such as a cell phone or automobile computer, an interactive TV, an Internet appliance, or the like. The PC may further include software application native to the device as well as software application served to the PC over a network connection (either a wired or wireless connection).

The methods may also be configured to be performed using a cluster of parallel processors and may also be served as a network application to local and/or remote users of the network.

The methods of the invention may be programmed for computation on a system of multiple processing cores to increase the overall computing performance and to reduce the processing time associated with accomplishing the performance of the method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A computer implemented method for defining transport logistic needs for a product, the method comprising:
a) providing the product's environmental sensitivity profile;
b) providing the product's shipment configuration profile;
c) defining a product shipment path;
d) creating a weather model associated with the product shipment path;
e) simulating the weather along the path during the selected timing;
f) calculating an environmental exposure of the product according to the shipment configuration profile and the simulated weather;
g) determining adverse product effects according to the environmental exposure and the environmental sensitivity profile; and
h) altering at last one of the: product, product shipment configuration, and product shipment path according to the determined adverse product effects.
